(19) United States
(12) Patent Application Publication
(10) Pub. No.: US 2021/0304047 A1
(43) Pub. Date: Sep. 30, 2021

(54) METHOD FOR ESTIMATING MISSING VALUES IN A DATASET

(71) Applicant: University of Louisiana at Lafayette, Lafayette, LA (US)

(72) Inventors: Khalid A Alattas, Lafayette, LA (US); Aminul Islam, Lafayette, LA (US); Ashok Kumar, Lafayette, LA (US); Magdy Bayoumi, Lafayette, LA (US)

(21) Appl. No.: 17/211,989

(22) Filed: Mar. 25, 2021

Related U.S. Application Data
(60) Provisional application No. 63/000,767, filed on Mar. 27, 2020.

(51) Int. Cl. G06N 7/00; G06F 17/18

(52) U.S. Cl. CPC G06N 7/005; G06F 17/18

(57) ABSTRACT

The inventive method uses mean and standard deviation of attributes and factors the relationship between attributes by using the correlation coefficients between attributes to estimate missing data in any given data set. The current invention provides the following benefits over the prior art: (1) using mean, standard deviation of attributes, and correlation coefficients between attributes to estimate the missing value of an attribute and (2) the time complexity of the proposed algorithm is better than those of the existing, prior art algorithms.

### CROSS REFERENCE TO RELATED APPLICATIONS

The application claims the benefit of and priority to U.S. Provisional Application No. 63/000,767, filed on Mar. 27, 2020 entitled “Missing Value Estimation in a Dataset.”

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### DESCRIPTION OF THE DRAWINGS

The drawings constitute a part of this specification and include exemplary embodiments of the METHOD FOR ESTIMATING MISSING VALUES A DATASET, which may be embodied in various forms. It is to be understood that in some instances, various aspects of the invention may be shown exaggerated or enlarged to facilitate an understanding of the invention. Therefore the drawings may not be to scale.

FIG. 1 is high-level intuition behind the Value Estimation based on Normalized Correlation algorithm.

FIG. 2 shows Algorithm 1, which computes the mean closeness score (tₓ) between attribute x and all the other attributes for object a, where xth attribute value of object a is missing.

FIG. 3 shows Algorithm 2, which computes the sign of tₓ and σₓ by counting the sign (i.e., + or −) between μᵢ and σᵢ in the following expression: |aᵢ−(μᵢ±σᵢ)| for all the attribute i, but i≠x.

### BACKGROUND

This invention is method which incorporates a novel unsupervised algorithm to estimate missing values in multi-attribute objects.

The impact of a missing attribute value can be extremely problematic in various applications such as dataset creation and data analysis. It can lead to biased information, biased estimation or projection, weakened statistical power, and decreased ability of findings from data.

One or more missing values in multi-attribute objects is a ubiquitous problem in the context of dataset creation, data analysis, machine learning, and data science. This problem has significant impact on social science and medical research. The absence of important attribute values in a dataset results in inaccurate predications and lower quality performance for various learning algorithms. Most real-world datasets are rarely “clean” and homogeneous so that missing attribute values is common.

There are various reasons for missing value in multi-attribute objects. Attribute value of some objects could be inaccessible, or, for instance, a subject failed to provide an attribute.

In the context of data analysis, missing values are one of the following three types: Missing Completely At Random (MCAR), Missing At random (MAR), and Not Missing At Random (NMAR).

MCAR means the propensity for an attribute value to be missing is completely random. That is, there is no relationship between whether an attribute value is missing and any values in the data set.

MAR means the propensity for an attribute value to be missing is not related to the missing data, but it is related to some of the observed data.

NMAR means the propensity for an attribute value to be missing varies for reasons that are unknown to us. That is, if the missing values do not randomly spread over all the objects and cannot be predicted using other objects present in the dataset, then these are considered as NMAR.

For example, if alumni data are randomly missing across all universities in the region, that data will be considered as MCAR. If the data regarding graduated students are randomly missing for some specific universities in the area, then the data are considered as MAR. If the data regarding all the graduated students from particular universities are missing, then that data can be considered as NMAR.

Generally, the easiest way to address this issue is to dispose of the objects (i.e., observations) that have missing attribute value from the dataset. As a result, the modified dataset will not have the missing value and can be used by traditional data analysis or machine learning methods. Commonly, this is the default approach applied to datasets with missing attribute values.

For example, Complete Case Analysis (also known as listwise deletion or casewise deletion), the default method for many statistical data software, deletes objects that appear with any missing value.

But, the major disadvantage of complete case analysis deletion is that it frequently removes a significant fraction of the dataset. Methods using this dataset may lead to misrepresented results because of the loss of valuable information.

The inventive method uses mean and standard deviation of attributes and factors the relationship between attributes by using the correlation coefficients between attributes.

Experimental results on three datasets show that the inventive algorithm outperforms or is comparable to two prior art algorithms/methods. The time complexity of the inventive algorithm is better than that of the prior art.

### DETAILED DESCRIPTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

The current invention provides the following benefits over the prior art: (1) using mean, standard deviation of attributes, and correlation coefficients between attributes to estimate the missing value of an attribute and (2) the time complexity of the proposed algorithm is better than those of the existing, prior art algorithms.

Complete case deletion or listwise deletion is the standard method to handle the missing values in the attributes (i.e., features). The listwise deletion method omits the object or observation that has missing value. By discarding these observations, it may remove a large ratio of cases with relevant information.

A popular technique for missing values is to replace missing values by mean (numeric attribute) or median (nominal attribute) that are computed from nonmissing observations. This approach is fast and easy to implement, but there are some problems. As this approach obviously deals with only column level and does not factor the relationships between attributes, it loses variation in data. Thus, the missing values will be identical for all observations in that column (i.e., attribute).

Imputation method is the process of substituting missing values with the predicted values using the existing part of the dataset.

Multiple Imputation (MI) was developed to manage missing values in medical and social sciences. MI analysis consists of two sequential steps: analysis of each complete individual dataset to perform multiple analysis results and then combining (pooling) these multiple analysis results. In other words, MI replaces missing values multiple times, and each missing value with a set of plausible values. The main idea of multiple imputation is to fill the missing parameter with multiple values. To do so, first, run a regression of distance from non-missing values versus missing values for subsample, and get the best approximation line for the subsample data. Then, find the first estimate for the missing values, and this is a single imputation method. To implement the MI, this procedure needs to be executed over and over again with other subsamples. The final stage of MI is to compute the mean or median of these multiple findings (i.e., missing values) to impute it to a single missing value. The downside of this method is that it gets different results every time it is used. Also, it is complex to implement. There is no implementation available for MI.

The only practical option is to use regression method that replaces the missing attribute values by a linear regression function rather than replacing all missing data with statistics. The downside of this method is that it does not work well when the relationship between attributes is not linear. In that case, the predicted missing attribute value will bias the model.

Although MI gives a different result every time it is used, Maximization-Likelihood Methods (ML) provides a unique result.

Expectation-Maximization (EM) algorithm is an implementation of the maximization-likelihood (ML) method. EM is an iterative algorithm to obtain maximum likelihood or maximum a posteriori (MAP) estimates of parameters in statistical models, where the model depends on unobserved hidden variables. The EM algorithm consists of two significant steps. The first step is the expectation step (E-step) and applies a current estimate of the parameter to find (expectation of) full data. The second step is the maximization step (M-step) and involves the updated data from the E-step to find a maximum likelihood estimate of the parameter. It includes iteratively computed expectations of terms in the log-likelihood function under the existing back part and then solving for the maxi-mum likelihood parameters.

For, Value Estimation based on Normalized Correlation (VENC), suppose there are m objects and each object has n attributes. Let an object a has |y| number of missing values, where y is a set of attributes and (|y|<n). The task is to determine the missing value of an object a and attribute x, where xεy. Compute Pearson's r between attribute x and the rest (n−1) attributes. So there will be (n−1) Pearson's r values. Suppose rᵢ means Pearson's r between attribute x and attribute i, where i≠x. Normalized Pearson's r between attribute x and i would be:

$${N}_{{r}_{i}} = \frac{\vert {r}_{i} \vert \times ( n - 1 )}{{Σ}_{i = 1 , i \neq x}^{n - 1} \vert {r}_{i} \vert} \qquad ( 1 )$$

Again, let aᵢ be the ith attribute value of object a, μᵢ be the mean of attribute column i, and σᵢ be the standard deviation of attribute column i.

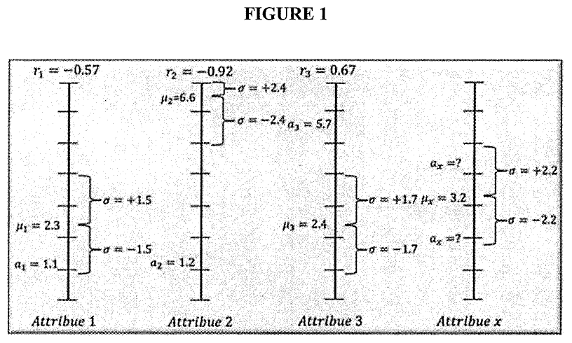

FIG. 1 is used to show the high-level intuition behind the inventive VENC algorithm. If object a's xth attribute value (i.e., aₓ) is missing, then the missing value is estimated based on the other attribute values (e.g., Attribute 1, 2, and 3) of the same object. The initial assumption is that the missing value would be close to the mean of Attribute x (i.e., μₓ). To compute the closeness with respect to μₓ), use the standard deviation, σₓ, of Attribute x. To compute the close-ness with respect to μ₁, μ₂, μ₃, use the mean closeness score, tₓ, of other attributes. As other attribute values are known, the closeness score estimates the closeness considering known attribute value, aᵢ, μᵢ, σᵢ, and Nrᵢ. That is, aₓ=μₓ±σₓ±tₓ. If a dataset has only one attribute x and object a is missing that attribute value then it is highly probable that the missing value would be within μₓ±σₓ. Now if other attributes are present then those attribute values of object a could be used to better estimate aₓ.

For example, in Attribute 2, a₂=1.2, μ₂=6.6, and σ₂=2.4. The idea is to find which one between μ₂+σ₂ and μ₂−σ₂ is closest to a₂ by using min (|a₂−(μ₂±σ₂)|). For Attribute 2, μ₂−σ₂ is closest and the difference between estimation (i.e., μ₂−σ₂) and actual value (i.e., a₂) is a₂−(μ₂−σ₂). Now, we use this learned difference/closeness to Attribute x by multiplying Nrᵢ with this (lines 6 and 8 of Algorithm 1).

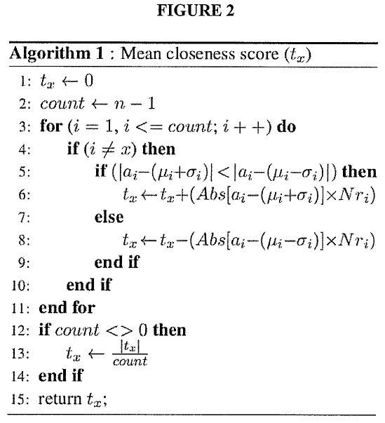

FIG. 2 shows Algorithm 1, which computes the mean closeness score (tₓ) between attribute x and all the other attributes for object a, where xth attribute value of object a is missing.

Object a's xth missing attribute value (i.e., aₓ) would be a function of μₓ, σₓ, and tₓ:

aₓ=μₓ+(Alg. 2)tₓ+(Alg. 2)σₓ (2)

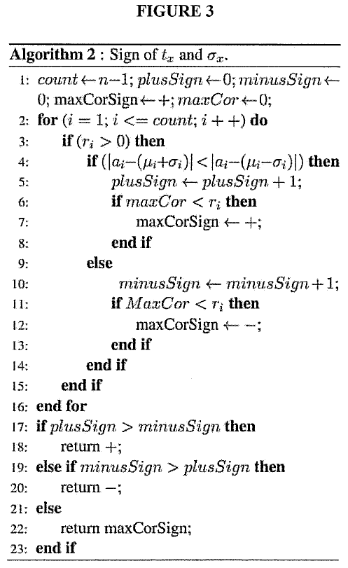

Here, the signs (i.e., whether tₓ and σₓ should be added or subtracted from μₓ before σₓ and σₓ are important. FIG. 3 shows Algorithm 2, which computes the sign of tₓ and σₓ by counting the sign (i.e., + or −) between μᵢ and σᵢ in the following expression: |aᵢ−(μᵢ±σᵢ)| for all the attribute i, but i≠x. If there is a tie then the sign of max (rᵢ) is used (lines 6, 7, 11, 12, and 22 of Algorithm 2).

If there is more than one missing value in an attribute, predict the first missing value, use this predicted value in the computation of and to predict the next missing value and so on until the values of μ and σ of that attribute get stable.

### Example

To evaluate the inventive method, three open datasets were used: Life Qualities of Countries (LQC) (GAPMINDER), Academic Ranking of World Universities (ARWU), and Center for World University Rankings (CWUR). LQC dataset presents data about the life qualities of 171 countries. ARWU and CWUR dataset present data about the top 100 academic rankings of world universities and the top 1000 global rankings of world universities, respectively.

Randomly remove 10%, 20%, 30%, 40%, and 50% attribute values from these datasets. Apply different algorithms such as VENC, EM, Regression, Zero Imputation, and Blank to populate those removed attribute values. Zero Imputation is the process of replacing the missing data with zero values. Blank means keep the missing values in the dataset, as is it without imputing any values.

Then use URMC algorithm to rank objects populated with missing values by the mentioned algorithms and compute Pearson's r correlation coefficients between URMC's rank and that of the ground-truth. The algorithm that better estimates the missing values of the ground-truth datasets will get higher Pearson's r correlation.

The results are summarized in the Table 1. Best performance per column is in bold. The result shows that with 50% missing values in the LQC, ARWU, and CWUR datasets, using the VENC algorithm to populate the missing data and URMC algorithm to rank the objects, it is possible to get 93%, 85%, and 90% Pearson's r correlation, respectively between URMC's rank and that of the ground-truth. The result is significant (T-test, the p-value is <0.00001) on these datasets.

TABLE 1

| | LQC Dataset | | | | | ARWU Dataset | | | | | CWUR Dataset | | | | |
|---|---|---|---|---|---|---|---|---|---|---|---|---|---|---|---|
| Method | 10% | 20% | 30% | 40% | 50% | 10% | 20% | 30% | 40% | 50% | 10% | 20% | 30% | 40% | 50% |
| VENC | 0.99 | 0.98 | 0.97 | 0.95 | 0.93 | 0.98 | 0.97 | 0.93 | 0.89 | 0.86 | 0.97 | 0.96 | 0.95 | 0.94 | 0.93 |
| EM | 0.99 | 0.98 | 0.96 | 0.93 | 0.90 | 0.98 | 0.97 | 0.92 | 0.88 | 0.85 | 0.96 | 0.95 | 0.94 | 0.93 | 0.92 |
| Regression | 0.94 | 0.90 | 0.88 | 0.85 | 0.82 | 0.93 | 0.89 | 0.85 | 0.81 | 0.79 | 0.90 | 0.89 | 0.84 | 0.83 | 0.80 |
| Zero Imputation | 0.91 | 0.83 | 0.76 | 0.71 | 0.69 | 0.89 | 0.78 | 0.64 | 0.61 | 0.53 | 0.92 | 0.90 | 0.88 | 0.87 | 0.84 |
| Blank | 0.92 | 0.90 | 0.85 | 0.83 | 0.80 | 0.91 | 0.90 | 0.72 | 0.68 | 0.61 | 0.93 | 0.91 | 0.89 | 0.83 | 0.79 |

The time complexity of both Algorithm 1 and 2 is of order n. As a result, the time complexity of VENC is also O(n). The time complexity of EM algorithms is O(nm). The time complexity of the Regression method in this task is O(c² nm)≈O(nm).

Thus, the unsupervised algorithm of the current invention successfully estimates missing values in multi-attribute objects by incorporating the mean and standard deviation of attributes with the correlation coefficients between attributes. Experimental results on three different datasets confirmed that the pro-posed algorithm is an improvement to the prior art.

For the purpose of understanding the METHOD FOR ESTIMATING MISSING VALUES IN A DATASET, references are made in the text to exemplary embodiments of a METHOD FOR ESTIMATING MISSING VALUES IN A DATASET, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

1. A method for estimating missing values in objects comprising a plurality of attributes by incorporating the mean and standard deviation of said attributes with the correlation coefficient between at least two said attributes.

2. An unsupervised algorithm method for estimating missing values in multi-attribute objects comprising:
a. identifying at least one missing attribute value and a plurality of non-missing attribute values;
b. determining the closeness of said missing attribute value to the mean of said plurality of non-missing attribute values using the standard deviation of said non-missing attribute values, said determination resulting in a mean closeness score.

3. The method of claim 2 wherein said missing attribute value is the sum of said mean of said plurality of non-missing attribute values, the standard deviation of said non-missing attribute values, and said closeness score.

4. The method of claim 3 further comprising calculating the sign of said closeness score by counting the sign between said mean of said non-missing attribute values and said standard deviation of said non-missing attribute values for all non-missing attributes.
